(19) United States
(12) Patent Application Publication
(10) Pub. No.: US 2015/0168213 A1
(43) Pub. Date: Jun. 18, 2015

(54) High-resolution Spectrometers Based on Substrate-guided Wave Holograms

(71) Applicant: Luminit LLC, Torrance, CA (US)

(72) Inventors: Fedor Dimov, Redondo Beach, CA (US); Chris Briffo, Torrance, CA (US); Jun Ai, Torrancel, CA (US); Xiaowel Xia, Torrance, CA (US); Neven Rakuljic, Santa Ana, CA (US)

(21) Appl. No.: 14/542,156

(22) Filed: Nov. 14, 2014

Related U.S. Application Data
(63) Continuation of application No. 61/904,696, filed on Nov. 15, 2013.

(51) Int. Cl. G01J 3/18

(52) U.S. Cl. CPC G01J 3/1838

(57) ABSTRACT

A SGWH-based spectrometer is disclosed that has the following advantages compared to prior art: compactness, high-resolution, high light throughput, high OOB rejection ratio, adjustability to the different wavebands, robustness and environmental stability.

### BACKGROUND OF THE INVENTION

Detailed day-by-day environmental sensing requires a large number of expensive, reliable, sensitive, high-resolution compact spectrometers. SOTA spectrometers based on regular optics (diamond turned gratings) are bulky and expensive. Even advanced miniature Ocean Optics spectrometers cost more than $3000 at a resolution ˜1 nm in NIR.

In conventional spectrometers spatial filters (narrow slits) are used to limit the angular range of the incident beam to get better resolution. This reduces the light throughput.

### SUMMARY OF THE INVENTION

Slitless high light throughput spectrometer geometry capable of measuring the high-resolution spectra of the spatially coherent or incoherent light in any part of visible or NIR spectra based on reflection substrate-guided wave holograms (SGWH) is disclosed herein; the method of recording the high resolution spectra is also disclosed herein.

By this invention a spectrometer is disclosed for preparing spectra of coherent and non-coherent light that includes
a first reflection SGWH lens,
a transparent substrate,
a second reflection SGWH lens, and
a 2D imaging sensor,

whereby the first reflection SGWH lens diffracts an incoming light beam, the diffracted lights propagate along the substrate via internal reflection, reaching the second reflector SGWH lens, which diffracts the light to the 2D imaging sensor, thereby forming spectral lines. In this invention the numerical aperture of the first reflection SGWH lens (diameter and focal distance) determines the wavelength bandwidth of the spectrometer and wavelength separation, and the focal distance of the 2^{nd} reflection SGWH lens determines the resolution of the spectral lines.

The subject invention also includes a method for preparing spectra of coherent and non-coherent light in a spectrophotometer comprising the steps of shining a light beam on a first reflection SGWH lens, diffracting the light beam and propagating it along a transparent substrate via internal reflection to a second reflection SGWH lens, diffracting the light beam with the second reflection SGWH lens to a 2D imaging sensor, and forming spectral lines. A further embodiment includes adjusting the diameter of the first reflection SGWH lens to adjust the wavelength bandwidth of the spectrophotometer, adjusting the focal distance of the first reflection SGWH lens to adjust the wavelength separation, and adjusting the 2^{nd} reflection SGWH lens to adjust the resolution of the spectral lines.

### CONCISE DESCRIPTION OF THE DRAWINGS

FIG. 1 is a schematic of the optical portion of the subject invention.

FIG. 2 is a photo of the through image of the substrate guided holographic cylinder lens when a collimated beam is passing through it.

FIG. 3 shows the recording geometry for a reflection SGWH played back with λp=765 nm (40); recording wavelengths λr=532 nm (41), λr=457 nm (42) λr=657nm (44) FIG. 4(a) shows parts of the krypton calibration source spectrum lines imaged by SGWH-based spectrometer.

FIG. 4(b) shows the same lines of FIG. 4(a) plotted using developed MatLab codes.

FIG. 5(a) is an Example of the spectrum image of the captured A-band spectrum using disclosed a SGWH-based spectrometer.

FIG. 5(b) is an Example of the Spectrum plot of FIG. 5(a).

### DETAILED DESCRIPTION OF ONE EMBODIMENT OF THE PRESENT INVENTION

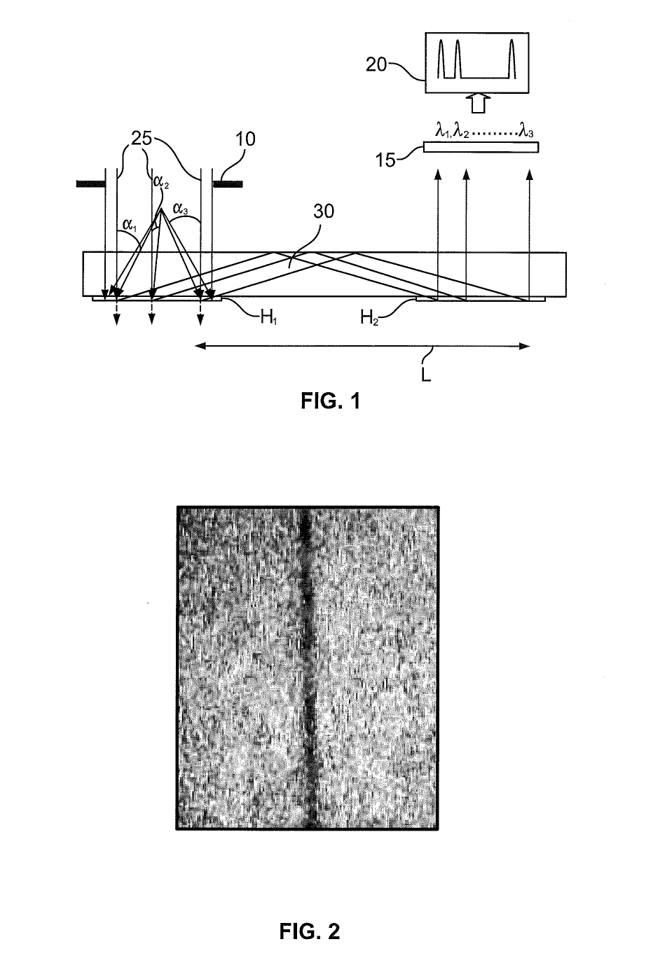

Input light coming from a distance enters the spectrometer through the opening that, together with the holographic optics, determines the bandwidth of the spectrometer. This opening is rather large (in the range of millimeters). It has nothing to do with the spectrometer resolution, and determines the spectrometer bandwidth. FIG. 1 demonstrates the disclosed spectrometer concept.

First reflection cylinder SGWH H₁ lens accepts the input light 25 and diffracts/couples the required part of the light spectrum (diffracted light 30) in the transparent substrate. This light propagates along the substrate via total internal reflection (TIR) effect, and reaches the second cylinder SGWH H₂ lens. This lens diffracts/couples this light out and focuses to the 2D imaging sensor 15 as a set of sharp spectral lines. Software processes these images and converts them to the plots that can be seen on the computer display screen 20.

FIG. 1 shows one of the possible arrangements of the optical portion schematic of the disclosed SGWH spectrometer. Angles α₁, α₂, α₃ are the angles between the playback collimated light that impinges on the SGWH H₁ lens during spectrum retrieval and the recording beam angle that impinges on the SGWH H₁ lens during holographic lens recording. Because the holographic lens is created by the recorded interference fringes that have a different slant, multiple (continuum) wavelengths that are included in the collimated beam themselves choose the part of the holographic lens that is in Bragg condition (has maximum diffraction efficiency) with the particular wavelength.

Depending on the application area and specifics of the required extracted information, the opening size that determines the wavelength bandwidth can vary. Also the length and thickness of the substrate can vary. Accordingly the diffracted beam angle and the number of total internal reflection (TIR) bounces of the light beam inside the substrate can vary.

Different diffracted beams correspond to different wavelengths and propagate along the substrate at different angles (disperse) according to Eq. 2-1 [L. Gu, et al., “Bandwidth-enhanced Volume Grating for Dense Wavelength-division Multiplexer Using a Phase-compensation Scheme”, App Phys Lett, vol. 86, p. 181103, 2005.], which defines the relationship between incident angle, diffracted angle, hologram slant and wavelength

(Λ/sin φ(sin α+sin β)=λ/n, (2-1)

where Λ is the hologram period, φ is the hologram angle (slant), λ is the light wavelength in a vacuum, n is the refractive index of the hologram material, and α and β are the respective incident and diffracted angles of the input and diffracted beams. Diffraction angle β is equal to the total internal reflection angle. Its change with the input signal wavelength can be found by differentiating Eq. (2-1). Accordingly, the linear dispersion can be expressed by the differentiation of Eq. (2-1) as well, L. Gu, et al., supra:

dL/dλ=2d(d(β/dλ)/(cos β)² , (2-2)

where d is the thickness of the substrate, L is the distance between input and output beams as shown in FIG. 1.

It is clear that the lateral dispersion capacity is dependent on the designed diffraction angle of the hologram β (that in turn depends on the hologram period) and its slant angle φ. The larger the diffraction angle (3 is, the greater the dispersion capacity. This analysis is correct for the case when SGWH H₁ and H₂ are gratings or lenses. For lenses, the variation of slant across the hologram should be taken into account. For better wavelength separation (means higher resolution), in regular spectrometers the slit 10 (FIG. 1) should be very narrow. This limits the light throughput. For thick SGWH, the hologram wavelength selectivity plays the role of the slit 10.

When the SGWH lens H₁ is played back with a monochrome collimated beam, the dark line in the passing zero order is visible, as shown in FIG. 2.

The straight dark line of FIG. 2 demonstrates that the thick holographic cylinder lens is diffracting a particular wavelength (in this case 532 nm) with the particular part of the cylinder lens (in this case it is close to the center of the lens) inside the substrate, so in the zero order this particular part of the hologram is dark.

This dark line is formed by varying the Bragg angle due to the hologram Bragg selectivity. Only a narrow angle range of beams corresponds to the Bragg condition and is diffracted (coupled) within the substrate.

The position of this line and its angle range and wavelength bandwidth depends on the SGWH lens numerical aperture, recorded and incident angles, wavelength, and hologram thickness.

Therefore, the thick hologram angular selectivity property replaces the slit function. When this property of thick holographic lens is combined with high angular and wavelength selectivity of thick SGWH, high resolution, a compact spectrometer can be built. This folded geometry has the advantage of high OOB (out of band) rejection ratio due to the minimized stray light that hits the 2D array sensor 15.

To accommodate the appropriate resolution and light throughput of the spectrometer, the SGWH H₁ and H₂ lenses should have appropriate numerical apertures. The numerical aperture of the lens H₁ (diameter and focal distance) determines the wavelength bandwidth of the spectrometer and wavelength separation. The focal distance of the H₂ lens determines the resolution provided that the 2D array sensor 15 can handle this resolution. There are appropriate sensors developed by Hamamatsu Photonics K. K., Sony, Toshiba that well fit this purpose.

### Method of Recording of Disclosed SGWH

General information about recording and playback of different types of SGWH can be found in F. Dimov et al, Patent Publication US2010/0157400 “Holographic Substrate-Guided Wave-Based See-Through Display”, which is incorporated herein in its entirety by reference.

The spectrometer that should work in the specific wavelength band SGWH recording setup should account for the wavelength change, because the available laser wavelengths and hologram recording materials are limited. The Bragg condition (playback angles θ_{P} for playback wavelengths λ_{P} different from recording wavelengths λ_{R}) can be calculated as

λ_{P}/λ_{R}=sin(θ_{P})/sin (θ_{R}). (3-1)

Some of the most frequently used, convenient, and available materials for thick SGWH and laser wavelengths are included in the Table 1 below.

TABLE 1
Examples materials for thick SGWH and
appropriate recording laser wavelengths

| | Holographic material | | | |
|---|---|---|---|---|
| | | Photo- | DuPont | Bayer |
| | | thermorefractive | Photo- | Photo- |
| | LiNbO₃ | (PTR) glass | polymer | polymer |
| Recording | 532 | 334 | 457 nm, | 440 nm, 532 nm, |
| wavelength, | | | 532 nm, | 650 nm and more |
| nm | | | 647 nm | within this range |

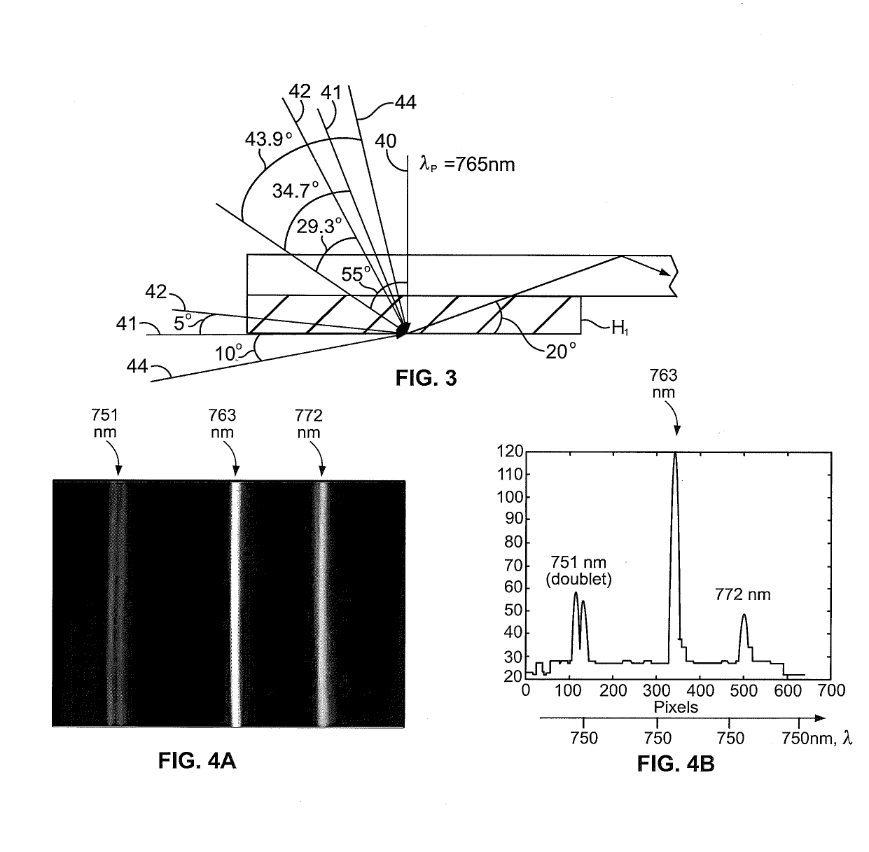

If the playback angles are known, the recording angles can be calculated with Eq. (3-1). For example, if a spectrometer is built that works in the atmospheric Oxygen A-band with the central wavelength 765 nm accounting for the normal incidence of the beams from atmosphere, a DuPont photopolymer can be chosen as a recording material for the SGWH. The reflection SGWH is chosen due to the higher than transmission SGWH dispersion. The recording wavelength can be chosen: either 457, or 532, or 647 nm considering the material sensitivity and convenience of recording setup, as understood from FIG. 3.

FIG. 3 shows the recording geometry for reflection SGWH played back (40) with λ_{P}=765 nm; recording wavelengths λ=532 nm (41), λr=457nm (42) λr=657 nm (44) All the angles are in medium with index of refraction n=1.5

### Experimental Confirmation of the Present Invention

A proof-of-concept spectrometer has been constructed for the atmospheric Oxygen A-band based on the above-described SGWH technology. FIG. 4(a) shows the images of the parts of the Krypton calibration light source spectrum captured by this spectrometer.

Appropriate plots of these scanned images along one horizontal line created with MATLAB software are shown in FIG. 4 (b). Table 2 lists the MATLAB codes.

TABLE 2
MATLAB Code to Plot Captured Spectrum

%This program plots a line cut from a JPEG image file
Clear all;
p=imread(‘532, 546 nm.jpg’); % read a RGB JPEG image
p=rgb2gray(p); % convert it to a gray image
row=p(100,;); % select a row
col=row’;
plot(col); %plot the profile of the row
clear all;

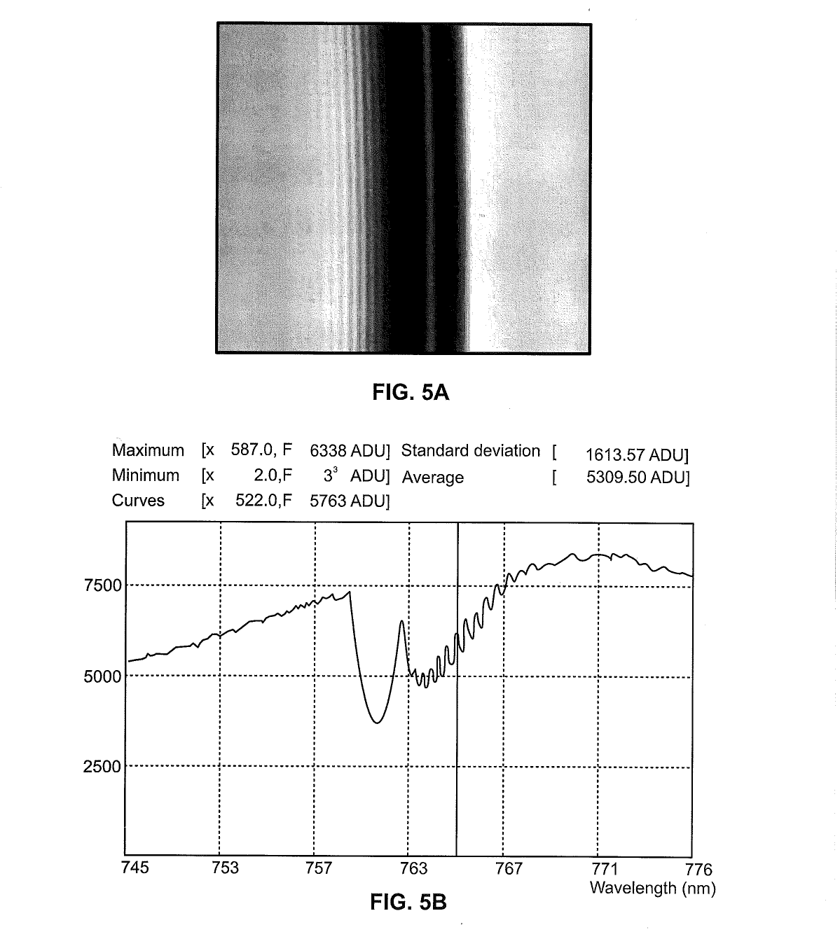

Based on the captured spectra images, the estimated resolution of this spectrometer with reflection SGWH lenses has ˜0.1 nm resolution. An example of the captured A-band spectrum using the disclosed SGWH-based spectrometer is shown in FIG. 5(a and b).

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A spectrometer for preparing spectra of coherent and noncoherent light comprising
a first reflection SGWH lens,
a transparent substrate,
a second reflection SGWH lens, and
a 2D imaging sensor,
whereby the first reflection SGWH lens diffracts an incoming light beam, the diffracted lights propagates along the substrate via internal reflection, reaching the second reflection SGWH lens, which diffracts the light to the 2D imaging sensor, thereby forming spectral lines.

2. The spectrometer of claim 1 wherein the diameter of the first reflection SGWH lens determines the wavelength bandwidth of the spectrometer.

3. The spectrometer of claim 1 wherein the focal distance of the first reflection SGWH lens determines the wavelength separation of the spectral lines.

4. The spectrometer of claim 1 wherein the focal distances of the 2^{nd} reflection SGWH lens determines the resolution of the spectral lines.

5. A method for preparing spectral of coherent and non-coherent light in a spectrophotometer comprising the steps of:
1) shining a light beam on a first reflection SGWH lens,
2) diffracting the light beam and propagating it along a transparent substrate via internal reflection to a second reflection SGWH lens;
3) diffracting the light beam with the second reflection SGWH lens to a 2D imaging sensor, and
4) forming spectral lines.

6. The method of claim 5 further including adjusting the diameter of the first reflection SGWH lens to adjust the wavelength bandwidth of the spectrophotometer.

7. The method of claim 5 further including adjusting the focal distance of the first reflection SGWH lens to adjust the wavelength separation.

8. The method of claim 5, further including adjusting the 2^{nd} reflection SGWH lens to adjust the resolution of the spectral lines.
